(19) United States
(12) Patent Application Publication
(10) Pub. No.: US 2004/0221130 A1
(43) Pub. Date: Nov. 4, 2004

(54) Method and device for a accessing non-volatile memory by PC and X-BOX

(76) Inventors: Jui Yang Lai, Renwu Shiang (TW); Hsin Ching Yin, Gangshan Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/834,994

(22) Filed: Apr. 30, 2004

(30) Foreign Application Priority Data
May 2, 2003 (TW) 092112100

(51) Int. Cl. G06F 12/08

(52) U.S. Cl. 711/203; 711/103

(57) ABSTRACT

A method for accessing a non-volatile memory by both PC and X-BOX is disclosed. The method includes the following steps: initializing a memory controller, preferably with a USB interface, for accessing the non-volatile memory; generating the first logical-to-physical address mapping table for mapping the first portion of the non-volatile memory; configuring the controller; monitoring the occurrence of an event; analyzing the starting logic address specified in a token packet sent from the host to the controller in response to the event; and generating the second logical-to-physical address mapping table for mapping the second portion of the non-volatile memory when its starting logic address is absent in the first logical-to-physical address mapping table.

### BACKGROUND OF THE INVENTION

1. Field of the Invention

The present invention relates to a method for accessing non-volatile memories by a personal computer and a game machine, such as an X-BOX game machine, as well as an associated controller for accessing the non-volatile memories for the personal computer and the game machine.

2. The Related Art

Personal computers (PCs) are provided with input/output ports for data communication. Universal Serial Bus (USB) port is one of employed standard interfaces on PCs, which is used to connect different USB peripherals, such as, a USB card reader, a USB storage, an external USB floppy disk drive, a USB printer, and a USB scanner. The transmission speed of USB has evolved from 12 Mbps supported in USB1.1 to 480 Mbps of USB2.0.

FIG. 1 shows a computer 100, comprises a USB receptacle 102 for mating a USB plug of a USB extension cord 140, through which the computer 100 is connected to a USB card reader 140. The USB card reader 140 is capable of accessing a flash memory card 180, such as, a compact flash, a SD/MMC, a micro drive, a smart media card and a memory stick.

FIG. 2 shows a game machine, especially an X-BOX available from Microsoft Corporation, designated with reference numeral 200, connected to a game pad 240. The game pad 240 has an X-BOX USB receptacle 242 for engaging an X-BOX game card 260. After the X-BOX game card 260 is inserted into the USB receptacle 242 on the game pad 240 and initialized, the X-BOX game card 260 is accessible by the X-BOX game machine 200. FIG. 2 also shows the X-BOX USB receptacle 202 on the X-BOX host, for receiving an X-BOX USB plug 205 and the USB receptacle 242 on the device. Because the USB receptacle 202 and the USB receptacle 242 on the X-BOX are specifically defined by Microsoft's own specification, the hardware structure and size are different from those of USB connector 102 on PCs. Conventionally, because the commands used in PCs and the X-BOX are different, the memory cards and the USB storage devices are not compatible between the two platforms.

### SUMMARY OF THE INVENTION

The present invention discloses a method for accessing a flash memory by both PC and X-BOX platforms, comprising the steps of: initializing the controller of the flash memory, preferably with a USB interface; generating a first logical-to-physical address mapping table, for mapping the first portion of the flash memory; configuring the controller; monitoring the occurrence of an event; analyzing the starting logical address in the token packet sent from the host to the controller in response to the event; and generating a second logical-to-physical address mapping table, for mapping the second portion of the flash memory when the starting logical address is absent in the first logical-to-physical address mapping table. The present invention also discloses a controller for accessing the flash memory by both PC and X-BOX platform, said controller comprising a ROM, a RAM and a microprocessor. Both the ROM and the RAM are coupled with the microprocessor. The ROM is pre-programmed with a firmware. The microprocessor operates with the firmware to generate a first logical-to-physical address mapping table and a second logical-to-physical address mapping table to map the first portion and the second portion of the flash memory.

The present invention further discloses a USB storage device, comprising a controller and a USB connector. The USB connector can be used to connect a first host so that the first host can access the USB storage device. The USB connector can also connect a second host through an adaptor so that the second host can access the USB storage device. The adaptor comprises a first USB connector and a second USB connector. In a preferred embodiment, the first host is a PC, and the second host is an X-BOX, while the USB storage device can be a USB flash drive, a USB card reader or a USB hard disk.

The present invention also discloses a controller for accessing a flash memory by both PC and X-BOX. The controller comprises a read only memory (ROM), a random access memory (RAM), and a microprocessor. The ROM is pre-programmed with a firmware, and the microprocessor is coupled with the ROM and the RAM. The microprocessor operates with the firmware to generate a first logical-to-physical address mapping table and a second logical-to-physical address mapping table in the RAM, in order to map the first portion and the second portion of the flash memory, respectively.

### BRIEF DESCRIPTION OF THE DRAWINGS

The present invention will be apparent to those skilled in the art by reading the following description of a preferred embodiment thereof, with reference to the attached drawings, in which:

FIG. 1 shows a PC connecting to a USB card reader through a USB extension cord according to the prior art;

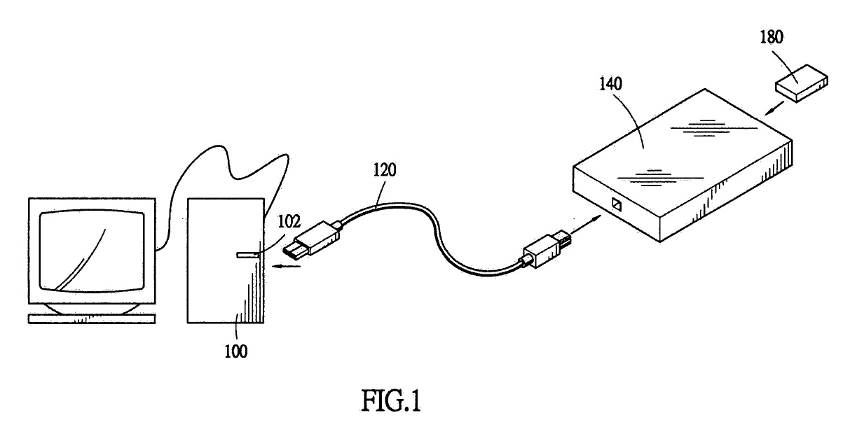

FIG. 2 shows an X-BOX connecting to a game pad through an X-BOX specific USB extension cord according to the prior art;

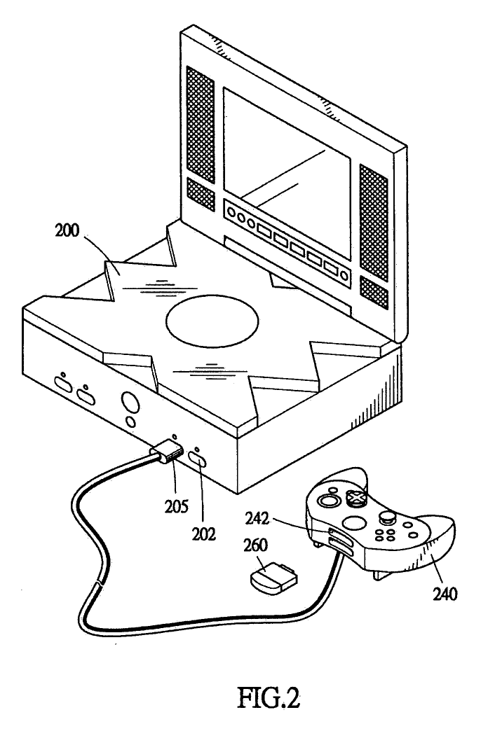

FIG. 3 shows the exemplary block diagram of an X-BOX game card;

FIG. 4 shows the exemplary block diagram of a USB card reader;

FIG. 5 shows the flowchart according to one embodiment of the present invention;

FIG. 6 shows the flowchart according to another embodiment of the present invention;

FIG. 7 shows an adaptor according to the present invention

FIG. 8 shows a memory mapping space according to one embodiment of the present invention;

FIG. 9 shows the flowchart according to another embodiment of the present invention;

FIG. 10 shows an adaptor according to the present invention; and

FIG. 11 shows a game pad according to the present invention.

### DETAILED DESCRIPTION OF THE PREFERRED EMBODIMENTS

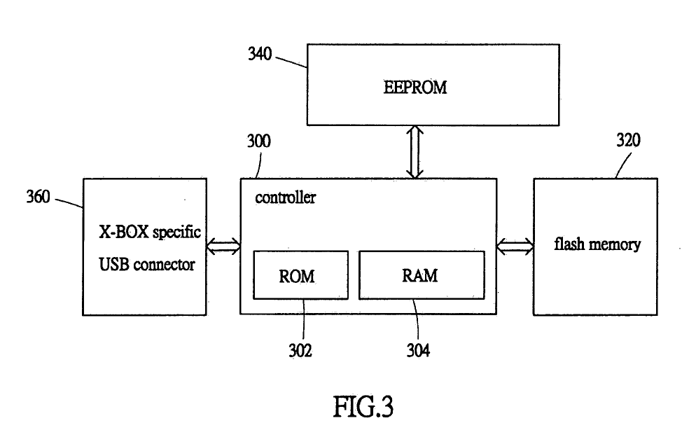

FIG. 3 shows a block diagram of an X-BOX game card. The controller 300 is coupled with a flash memory 320, an electrically erasable programmable read only memory (EEPROM) 340, and an X-BOX specific USB connector 360 for connecting the X-BOX game pad. The EEPROM 340 stores the basic setting of the controller 300, and the flash memory, for example, has the size of 8 M bytes. The controller 300 includes a ROM 302, a RAM 304, and a microprocessor (not shown). The ROM 302 is pre-programmed with the firmware for the controller 300. Because the controller 300 directly controls the access of the flash memory 320, the controller 300 must generate a mapping table between the physical address and the logical address in order to access the flash memory 320 according to the physical address.

Because the commands from the PC and the X-BOX to the USB device are different, the USB storage devices developed for one platform can not be applied to the other. On the PC platform, the host uses the following commands to access the USB storage devices: Get_MAX_LLN, INQUIRY, TEST UNIT READY, PREVENT ALLOW MEDIUM REMOVAL, READ_CAPACITY, READ(10), WRITE(10), and so on. On the other hand, the X-BOX uses the following commands: READ_CAPACITY, READ(10), WRITE(10), and so on. In the embodiment shown in FIG. 3, the flash memory 320 is, for example, 8 M bytes, divided into 1024 blocks. Each block contains 16 pages, and each page is 512 bytes. Since the unit of access of the flash memory 320 is a block, the mapping table generated by the controller 300 may contain 1024 words. This structure will operate normally on the PC platform. But it is difficult for the same hardware and firmware to be applied on the X-BOX platform. Since the X-BOX commands have more restrictions than on the PC platform, the structure used for the PC platform fails the X-BOX system. For example, when the X-BOX host sends a READ_CAPCITY command to the USB storage device, it has a restriction shorter than 150 ms. Also, the controller 300 requires a rather long time to generate the 1024-word mapping table for the 8M flash memory. Therefore, when the READ_CAPACITY command is not responded within 150 ms, the X-BOX host will issue a RESET command to the USB storage device, so that the USB storage device cannot establish a connection with the X-BOX host.

The Get_MAX_LUN command is used to determine the number of the logical units that a USB storage device can support. The INQUIRY command is used to determine the configuration of the SCSI bus, and the target device must respond with its type, vendor ID, product ID, USB class and associated information. The TEST UNIT READY command allows the initiator to inquire if the logical unit is ready, without allocating space for returned data. This is especially useful for removable media, such as cartridges. The PREVENT ALLOW MEDIUM REMOVAL command allows the initiator to issue the command to prevent the medium from removal. The READ_CAPACITY command allows the initiator to request for capacity information of the logical unit. The READ(10) command reads the data from the target device back to the initiator, and the WRITE(10) command writes the data from the initiator to the target device.

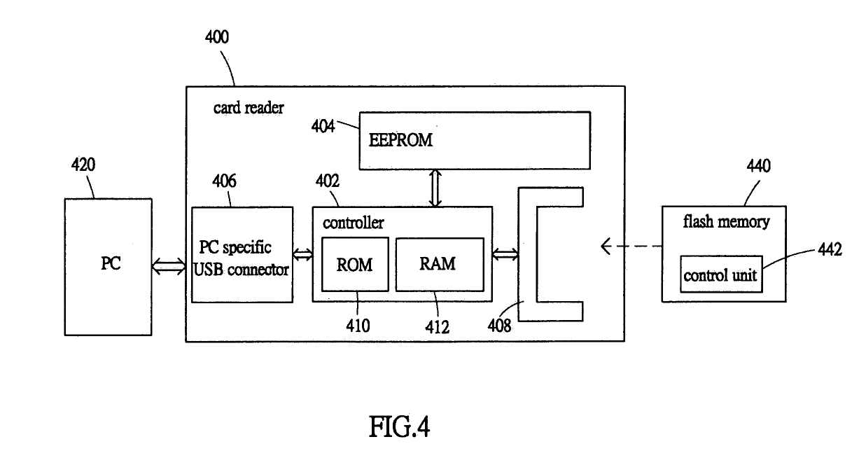

FIG. 4 shows a block diagram of a card reader used on the PC platform. The card reader 400 comprises a controller 402, an EEPROM 404, a PC specific USB connector 406 and a flash memory connector 408. The controller 402 is coupled with the EEPROM 404, the PC specific USB connector 406, and the flash memory connector 408. The PC specific USB connector 406 is for connecting to a PC 420, and the flash memory connector 408 is for receiving and accessing a flash memory 440 for the card reader 400. The controller 402 comprises a ROM 410, a RAM 412, and a microprocessor (not shown). The ROM is pre-programmed with the firmware for the controller 402. Because the flash memory 440 has its own control unit 442, the controller 402 issues access commands in order to access the flash memory 440, without requiring generating a mapping table.

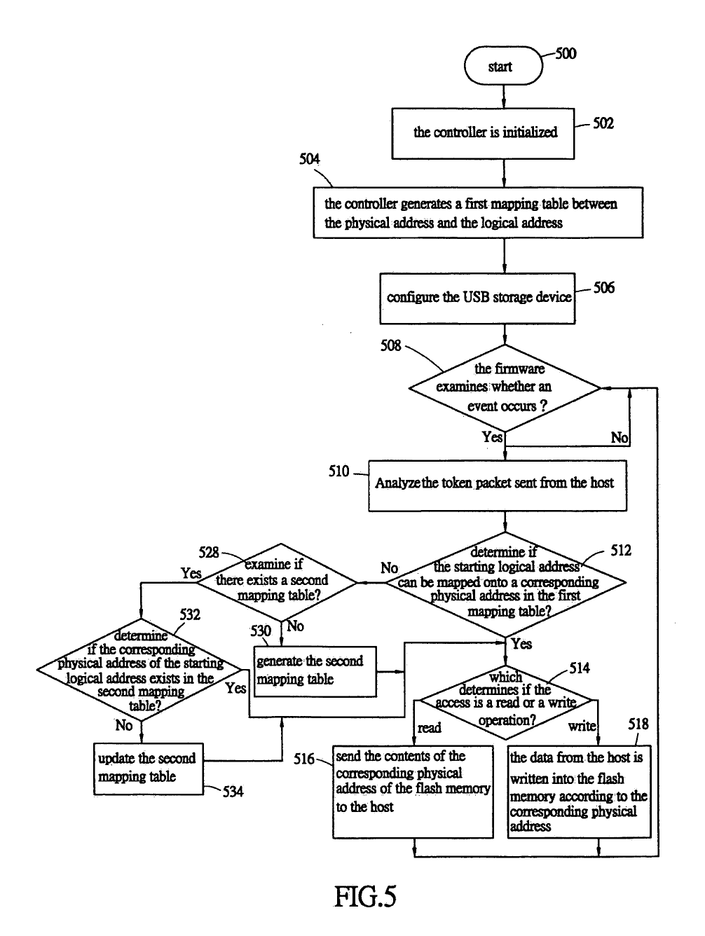

FIG. 5 shows a flowchart for accessing a non-volatile memory by a PC and an X-BOX according to one embodiment of the present invention. Take the flash memory as an example, the method starts at step 500. At step 502, the controller 300 is initialized, such as initializing the RAM 304 to zero, raising the voltage to 3.3V, and loading the basic setting from EEPROM 340. At step 504, the controller 300 generates a first mapping table between the physical address and the logical address. For example, a 512-word first mapping table is generated. Step 506 is to configure the USB storage device, which will be explained in more details later. In step 508, the firmware examines whether an event occurs. If so, proceed to step 510; otherwise, stay in step 508. Step 510 is to analyze the token packet sent from the host, and obtain the required information, such as, the starting logical address where the host intends to access, data read, data write, the size of the data, and so on. Step 512 determines if the starting logical address can be mapped onto a corresponding physical address in the first mapping table. If so, proceed to step 514, which determines if the access is a read or a write operation. If it is a read operation, send the contents of the corresponding physical address of the flash memory 320 to the host, as shown in step 516. On the other hand, at step 518, if it is a write operation, the data from the host is written into the flash memory 320 according to the corresponding physical address. After the read or write operation, the process returns to step 508, in which the firmware continues monitoring the occurrence of events.

In step 512, if the corresponding physical address of the starting logical address can not be found in the first mapping table, proceed to step 528. At step 528, examine if there exists a second mapping table. If the second mapping table does not exist, proceed to step 530 to generate it. For example, in this embodiment, a 256-word second mapping table can be generated, and then proceed to step 514. On the other hand, if the second mapping table exists, proceed to step 532 to determine if the corresponding physical address of the starting logical address exists in the second mapping table. If the corresponding physical address is found, proceed to step 514. Otherwise, perform step 534 to update the second mapping table, and then proceed to step 514. According to the aforementioned structure of generating the first and the second mapping tables, it facilitates applying the same firmware on both PC and X-BOX platforms.

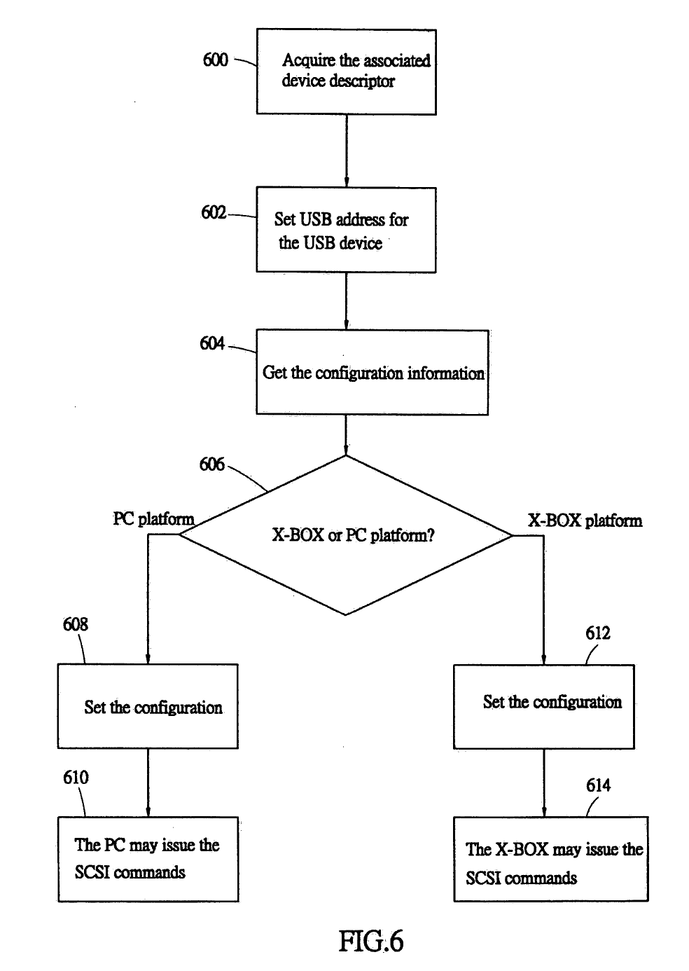

Furthermore, the USB storage device according to the present invention is capable of determining whether the platform that it is currently connected to is a PC platform or an X-BOX platform. In this embodiment, this is performed in step 506, configuring the USB device, as shown in more details in FIG. 6. For the USB storage devices, the USB general commands are usually followed by the USB storage class commands. Steps 600, 602, and 604 relate to the USB general commands. Step 600 indicates that the host issues a Get_Device_Desc command to the USB device to obtain the associated device descriptor, including vendor ID, product ID, USB class, and so on. The host then issues a Set_Addr command to set USB address for the USB device in step 602. At step 604, the host issues a Get_Configuration_Desc command to get the configuration information, including configuration descriptor, interface descriptor, endpoint descriptor, and so on. Therefore, the host can identify the USB device as a USB storage device. In step 606, the USB device determines what kind of the platform is, according to the bInterfaceSubClass in the interface descriptor of the configuration. If bInterfaceSubClass equals 06, it represents that this is a PC platform; if bInterfaceSubClass equals to 42, it represents that this is an X-BOX platform. According to the platform the USB device is connected to, the command Set_Configuration is performed at step 608 and step 612, respectively. As the host identifies the USB device being a USB storage device, it issues SCSI commands corresponding to the operating platform in step 610 and step 614, respectively. At step 610, the PC may issue the SCSI commands, including Get_MAX_LUN, INQUIRY, TSET UNIT READY, PREVENT ALLOW MEDIUM REMOVAL, READ_CAPACITY, READ(10) and WRITE(10). However, at step 614, the X-BOX may issue the SCSI commands, including READ_CAPACITY, READ(10), and WRITE(10).

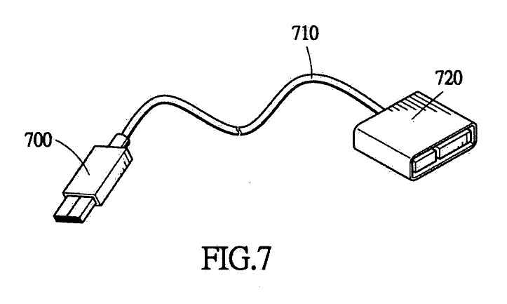

The controller of the X-BOX game card may be implemented as the cross-platform memory access structure shown in FIGS. 5 and 6, it requires a proper adaptor to serve as a flash drive for a PC. The adaptor of the present invention, as shown in FIG. 7, comprises a USB plug for PC 700, a signal cable 710, and a USB device receptacle for an X-BOX 720. The user can insert the X-BOX game card in the X-BOX USB device receptacle 720 and connect the PC USB plug 700 to the PC, so that the X-BOX game card can operate as a flash drive for a PC. The adaptor can also be implemented as a dual-connector adaptor without the signal cable 710. FIG. 7 shows two USB connectors, one for PC, and the other for X-BOX device. In spite that the connectors for the two platforms are different, wherein both connectors comprise 4 lines: D+, D−, PWR and GND. In the X-BOX platform, there is one additional USB signal line, which is reserved for future application. The D+ and D− lines are for transceiving the differential signal, and PWR and GND lines represent the power and ground, respectively. Therefore, the adaptor of the present invention provides two types of connectors for the two platforms, and their internal lines are wired correspondingly.

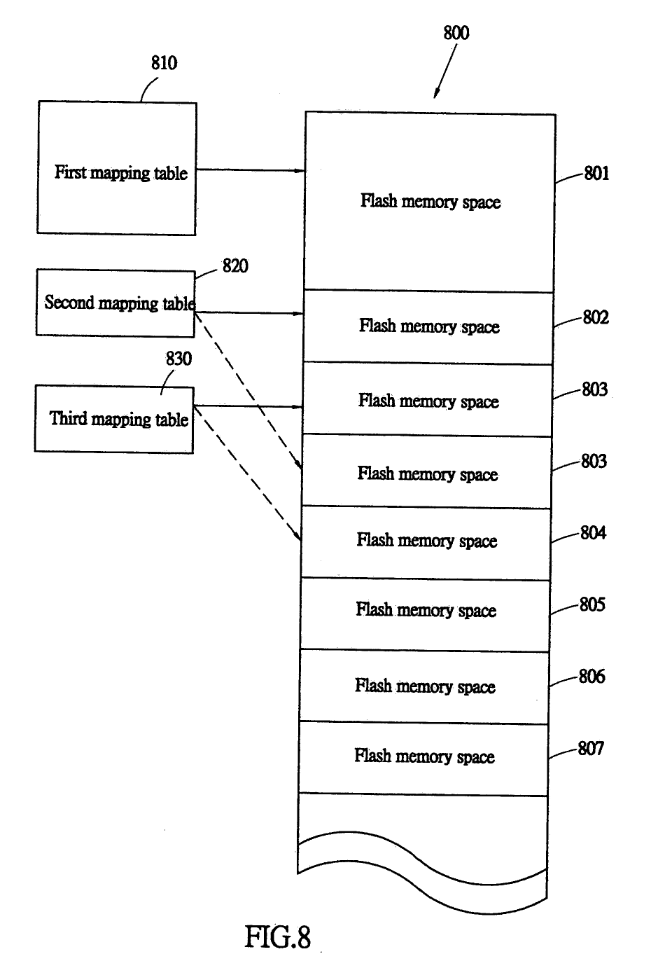

FIG. 8 shows another embodiment of the present invention. Referring to the hardware structure in FIG. 3, the use of the memory shown in the flowchart of FIG. 5 can be further enhanced for better performance. Take a 32M flash memory 800 as an example, the flash memory 800 represents the logical space mapping of the flash memory 320 in FIG. 3. The address of memory location is in the increasing order from the top to the bottom, including flash memory block 801, 802, 803, 804, 805, 806, and 807. Similar to the flowchart in FIG. 5, the firmware may generate a 512-word first mapping table 810 and a 256-word second mapping table 820 in the controller 300 while initializing the USB storage device. The first mapping table 810 can map the 4M flash memory block 801, and the second mapping table can map the 2M flash memory block 802. Since the flash memory 320 has a long access delay, a 256-word third mapping table 830 can be generated in RAM 304 of the controller 300 to map the flash memory block 803 during the subsequent accessing to the flash memory blocks 801 and 802. Of course, the second mapping table 820 can be also generated during the subsequent accessing to the flash memory block 801 to save time. Preferably, the first mapping table 810 maps the lowest address of the flash memory, where the file allocation table (FAT) is located and frequently accessed. Similarly, when subsequently accessing flash memory blocks 801 and 803, the second mapping table 820 can be updated, and a mapping table for the flash memory block 804 can be generated. In this way, the entire flash memory 800 can be accessed in turn.

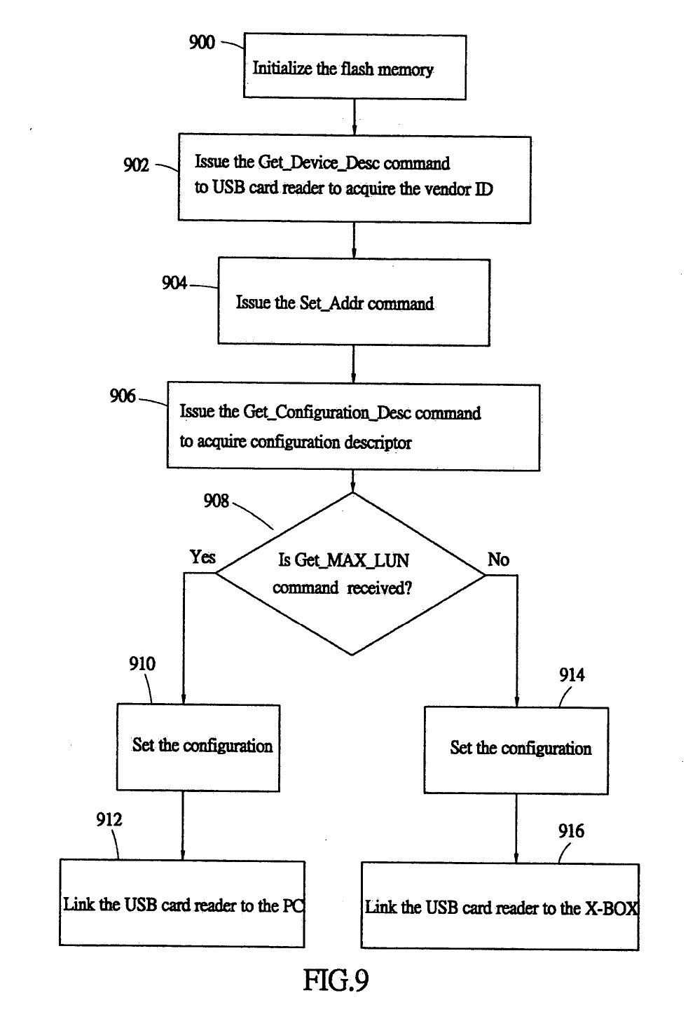

FIG. 9 shows the flowchart according to another embodiment of the present invention. Please refer to the block diagram of the USB card reader for PC platform in FIG. 4. The controller 402 should only issue access commands to access the flash memory card 440, as the flash memory card 440 has its own control unit 42 internally. In the other words, the controller 402 needs not generate any address mapping table. In general, when the controller 402 issues a reset command to the flash memory card 440, it will inquire the flash memory about the capacity information and the size of each page, which are time-consuming operations. For the same hardware and firmware to be used on the X-BOX platform, it conventionally encounters serious problems. Since the X-BOX commands have strict restriction, it easily fails the system. For example, when the host sending a READ_CAPCITY command to the USB storage device, it has the restriction of 150 ms. When the operations are not properly designed and the READ_CAPACITY command is not responded within 150 ms, the host will issue a RESET command to the USB storage device, so that the USB storage device cannot successfully establish the connection with the host.

At step 900 in FIG. 9, the flash memory 440 is initialized at first according to the embodiment of the present invention, in order to avoid the more restrictive commands of the X-BOX platform. Step 902 shows the host issuing the Get_Device_Desc commands to USB card reader to acquire the vendor ID, the product ID and the USB class. Step 904 shows the host issuing the Set_Addr command, and step 906 showing the host issuing the Get_Configuration_Desc command to acquire configuration descriptor, Interface descriptor and endpoint descriptor. Therefore, the host knows the USB card reader is a USB storage device. In step 908, the USB card reader can determine which platform it is connected to according to, for example, whether a Get_MAX_LUN command is received. If it receives a Get_MAX_LUN command, the USB card reader is determined as being physically connected to a PC. Next proceeds to step 910 to set the configuration, and then step 912 to link the USB card reader to the PC. On the other hand, if it the Get_MAX_LUN command is not observed, it is determined as being physically connected to an X-BOX platform. Next proceeds to step 914 to set the configuration, and then step 916 to link the USB card reader to the X-BOX. The USB card reader can also determine the platform according to whether receiving INQUIRY, TEST UNIT READY or PREVENT ALLOW MEDIUM REMOVAL command.

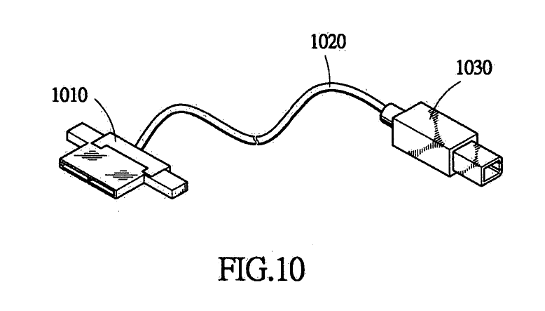

FIG. 10 shows an adaptor, comprising an X-BOX USB device connector 1010, a signal cable 1020, and a PC USB device plug 1030. The X-BOX USB device plug 1010 is connected to the X-BOX game pad, so that the USB card reader for PC platform can be used on the X-BOX. Therefore, the user can use various flash memory cards for PC platform, including compact flash, SD/MMC, smart media, and memory stick, to store the game files of X-BOX game machine. The adaptor can also be used as a dual-connector adaptor without the signal cable 1020. That is, it provides two USB plugs, one for PC device, and the other for X-BOX device. In spite that the profiles of the two plugs for the two platforms are different, they both have 4 lines: D+, D−, PWR and GND. In the X-BOX platform, there is one additional USB signal line, which is reserved for future use. The D+ and D− lines are for transceiving the differential signal, and PWR and GND lines are for the power and ground, respectively. Therefore, the adaptor according to the present invention provides two types of plugs for the two platforms, and their internal lines are correspondingly coupled. Alternatively, the USB storage device for PC platform can be connected to X-BOX machine through the present adaptor to for access across.

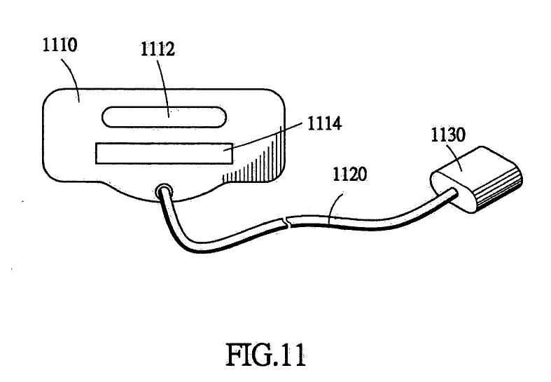

Furthermore, FIG. 11 shows a game pad according to the present invention. The game pad comprises a pad body 1110, a cable 1120, and a USB plug 1130. In a preferred embodiment, the game pad is connected to an X-BOX through the USB plug 1130, or alternatively, connected to a PC through an appropriate adaptor. The pad body 1110 comprises an X-BOX USB receptacle 1112 and a flash memory card receptacle 1114. The X-BOX USB receptacle 1112 is for X-BOX game cards, or X-BOX earphone, and so on. The flash memory card receptacle 1114, preferably a CF card receptacle for receiving a CF card. Other flash memory cards, including SD/MMC, micro drive, smart media, and memory stick, can be received by the receptacle 1114 through an appropriate memory interface card adaptor (not shown). The internal operations of the controller for the various card readers can be found in reference to Taiwan Patent Application No. 91207750 by the present inventor.

The present invention discloses a method for accessing a flash memory by both PC and X-BOX platforms, comprising the steps of: initializing the controller of the flash memory, preferably with a USB interface; generating a first logical-to-physical address mapping table, for mapping the first portion of the flash memory; configuring the controller; monitoring the occurrence of an event; analyzing the starting logical address in the token packet sent from the host to the controller in response to the event; and generating a second logical-to-physical address mapping table, for mapping the second portion of the flash memory when the starting logical address is absent in the first logical-to-physical address mapping table. The present invention also discloses a controller for accessing the flash memory by both PC and X-BOX platform, said controller comprising a ROM, a RAM and a microprocessor. Both the ROM and the RAM are coupled with the microprocessor. The ROM is pre-programmed with a firmware. The microprocessor operates with the firmware to generate a first logical-to-physical address mapping table and a second logical-to-physical address mapping table to map the first portion and the second portion of the flash memory.

The present invention further discloses a USB storage device, comprising a controller and a USB connector. The USB connector can be used to connect a first host so that the first host can access the USB storage device. The USB connector can also connect a second host through an adaptor so that the second host can access the USB storage device. The adaptor comprises a first USB connector and a second USB connector. In a preferred embodiment, the first host is a PC, and the second host is an X-BOX, while the USB storage device can be a USB flash drive, a USB card reader or a USB hard disk.

The present invention also discloses a controller for accessing a flash memory by both PC and X-BOX. The controller comprises a read only memory (ROM), a random access memory (RAM), and a microprocessor. The ROM is pre-programmed with a firmware, and the microprocessor is coupled with the ROM and the RAM. The microprocessor operates with the firmware to generate a first logical-to-physical address mapping table and a second logical-to-physical address mapping table in the RAM, in order to map the first portion and the second portion of the flash memory, respectively.

While the invention has been described in connection with what is presently considered to the most practical and preferred embodiment, it should be understood that the invention does not intend to be limited to the disclosed embodiments, for example, the EEPROM can be integrated into the controller in the block diagrams in FIGS. 3 and 4. But on the contrary, the invention is intended to cover various modifications and equivalent arrangement included within the spirit and scope of the appended claims.

What is claimed is:

1. A method for accessing a non-volatile memory, comprising the steps of:
initializing a controller for accessing said non-volatile memory, the controller having a USB interface;
generating a first logical-to-physical address mapping table, for mapping a first portion of said non-volatile memory;
configuring said controller;
monitoring an event;
analyzing a token packet sent from the host to said controller to obtain a starting logical address being in response to said event; and
generating a second logical-to-physical address mapping table, for mapping a second portion of said non-volatile memory when said starting logical address is absent in said first logical-to-physical address mapping table.

2. The method as claimed in claim 1 further comprising a step of mapping said starting logical address onto a corresponding physical address in said first mapping table when said starting logical address exists in said first mapping table, so as to allow said controller to access said physical address in said non-volatile memory in response to said token packet.

3. The method as claimed in claim 1 further comprising steps of mapping said starting logical address onto a corresponding physical address in said second mapping table when said starting logical address is absent in said first mapping table; and said controller to access said physical address in said non-volatile memory in response to said token packet.

4. The method as claimed in claim 1, wherein the size of said first logical-to-physical address mapping table is substantially larger than the size of said second logical-to-physical address mapping table.

5. The method as claimed in claim 1 further comprising a step of: updating said second logical-to-physical mapping table to map a third portion of said non-volatile memory when said starting logical address is absent in said first mapping table and said second mapping table.

6. The method as claimed in claim 5 further comprising a step of mapping said starting logical address onto a corresponding physical address in said updated second mapping table, so as to allow said controller accessing said physical address in said non-volatile memory in response to said token packet.

7. The method as claimed in claim 1, wherein said configuring step comprises steps of: acquiring a device descriptor; setting an address for said controller; and acquiring a configuration information.

8. The method as claimed in claim 7, wherein said configuration information comprises a configuration descriptor, an interface descriptor, and an endpoint descriptor.

9. The method as claimed in claim 7, wherein said interface descriptor comprises a bInterfaceSubClass field; wherein when said bInterfaceSubClass field equals to 06, said controller determines the platform is a PC, and when said bInterfaceSubClass field equals to 42, said controller determines the platform is an X-BOX.

10. A method for accessing a non-volatile memory, comprising the steps of:
initializing a controller for accessing said non-volatile memory;
generating in said controller a first logical-to-physical address mapping table for mapping a first portion of said non-volatile memory;
receiving a token packet containing a starting logical address;
generating in said controller a second logical-to-physical address mapping table for mapping a second portion of said non-volatile memory;
generating in said controller a third logical-to-physical address mapping table for mapping a third portion of said non-volatile memory;
mapping said starting logical address to a physical address utilizing said first mapping table, said second mapping table, and said third mapping table; and
accessing said corresponding physical address of said non-volatile memory in response to said token packet.

11. The method as claimed in claim 10, wherein in said generating the third mapping table step, said third mapping table is generated while said starting logical address is present in said second mapping table and said controller is accessing said physical address of said non-volatile memory in response to said token packet.

12. The method as claimed in claim 10 further comprising a step of: updating said second mapping table while said starting logical address is present in said third mapping table and said controller is accessing said physical address of said non-volatile memory in response to said token packet.

13. The method as claimed in claim 10 further comprising a step of: updating said third mapping table while said starting logical address is present in said second mapping table and said controller is accessing said physical address of said non-volatile memory in response to said token packet.

14. A controller for accessing a non-volatile memory, comprising:
a read-only memory (ROM), pre-programmed with a firmware;
a random access memory (RAM); and
a microprocessor, coupled to said ROM and said RAM,
wherein said microprocessor operates with said firmware to generate in said RAM a first logical-to-physical address mapping table and a second logical-to-physical address mapping table, in order to map a first portion and a second portion of said non-volatile memory, respectively.

15. The controller as claimed in claim 14, wherein said microprocessor uses said firmware to generate in said RAM a third logical-to-physical address mapping table for mapping a third portion of said non-volatile memory.

16. The controller as claimed in claim 15, wherein said microprocessor generates a third logical-to-physical address mapping table while a starting logical address is present in said second mapping table and said controller is accessing said non-volatile memory in response to said starting logical address.

17. The controller as claimed in claim 15, wherein said microprocessor updates said second logical-to-physical address mapping table while a starting logical address is present in said third mapping table, and said controller is accessing said non-volatile memory in response to said starting logical address.
